(19) United States
(12) Patent Application Publication
(10) Pub. No.: US 2017/0095803 A1
(43) Pub. Date: Apr. 6, 2017

(54) Effect of Type of Support Oxide on Sulfur Resistance of Synergized PGM as Diesel Oxidation Catalyst

(71) Applicant: Clean Diesel Technologies, Inc., Oxnard, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Oxnard, CA (US)

(21) Appl. No.: 14/872,532

(22) Filed: Oct. 1, 2015

(51) Int. Cl. B01J 27/25; B01J 37/04; B01J 37/02; B01J 37/00; B01J 23/63; B01J 37/08

(52) U.S. Cl. CPC B01J 27/25; B01J 23/63; B01J 37/08; B01J 37/0244; B01J 37/0009; B01J 37/04

(57) ABSTRACT

Sulfur-resistant synergized platinum group metals (SPGM) catalysts with significant oxidation capabilities are disclosed. Catalytic layers of SPGM catalyst samples are produced using conventional synthesis techniques to build a washcoat layer completely or substantially free of PGM material. The SPGM catalyst includes a washcoat layer comprising YMnO₃ perovskite and an overcoat layer including a Pt composition deposited on a plurality of support oxides with total PGM loading of about 5 g/ft³. Resistance to sulfur poisoning and catalytic stability is observed under 1.3 gS/L condition to assess the influence that selected support oxides have on the DOC performance of the SPGM catalysts. The results indicate SPGM catalysts produced to include a layer of low amount of PGM catalyst material deposited on a plurality of support oxides added to a layer of ZPGM catalyst material are capable of providing significant improvements in sulfur resistance of SPGM catalyst systems.

### BACKGROUND

Field of the Disclosure

This disclosure relates generally to diesel oxidation catalysts for the treatment of exhaust gas emissions from diesel engines, and more particularly, to sulfur-resistant synergized platinum group metals (SPGM) catalyst systems with low platinum group metals (PGM) loading.

Background Information

Diesel oxidation catalysts (DOCs) include PGM deposited on a metal support oxide. DOCs are used in treating diesel engine exhaust to reduce nitrogen oxides (NO_{X}), hydrocarbons (HC), and carbon monoxide (CO) gaseous pollutants. The DOCs reduce the gaseous pollutants by oxidizing them.

Conventional catalytic converter manufacturers utilize a single PGM catalyst within their diesel exhaust systems. Since a mixture of platinum (Pt) and palladium (Pd) catalysts within the PGM portion of a catalytic system offer improved stability, the catalytic converter manufacturing industry has moved to manufacturing Pt/Pd-based DOCs.

In diesel engines, the sulfur present in the exhaust gas emissions may cause significant catalyst deactivation, even at very low concentrations. This catalyst deactivation is due to the formation of strong metal-sulfur bonds. The strong metal-sulfur bonds are created when sulfur chemisorbs onto and reacts with the active catalyst sites of the metal. The stable metal-adsorbate bonds can produce non-selective side reactions which modify the surface chemistry.

Current attempts to solve this problem have led manufacturers to produce catalyst systems with improved sulfur resistance. Typically, these catalyst systems are manufactured by using high loadings of PGM. Unfortunately, utilizing high loadings of PGM within catalyst systems increases the cost of the catalyst systems because PGMs are expensive. PGMs are expensive because they are scarce, have a small market circulation volume, and exhibit constant fluctuations in price and constant risk to stable supply, amongst other issues.

Accordingly, as stricter regulatory standards are continuously adopted worldwide to control emissions, there is an increasing need to develop DOCs with improved properties for enhanced catalytic efficiency and sulfur poisoning stability.

### SUMMARY

The present disclosure describes synergized PGM (SPGM) catalysts with low PGM loading for diesel oxidation catalyst (DOC) applications.

It is an object of the present disclosure to describe SPGM catalyst systems having a high catalytic activity and resistance to sulfur poisoning. In these embodiments, a catalytic layer of 5 g/ft³ of PGM active component is synergized with Zero-PGM (ZPGM) catalyst compositions including a perovskite structure in a separate catalytic layer. In some embodiments, the disclosed 2-layer SPGM catalysts can provide catalyst systems exhibiting high oxidation activity as well as sulfur resistance.

According to some embodiments, the SPGM DOC systems can be configured to include a washcoat (WC) layer of ZPGM material compositions deposited on a plurality of support oxides of selected base metal loadings. In these embodiments, the WC layer can be formed using a YMnO₃ perovskite structure deposited onto doped ZrO₂ support oxide.

In further embodiments, a second layer of the disclosed SPGM DOC system is configured as an overcoat (OC) layer. The OC layer includes a plurality of low PGM material compositions on support oxides. In these embodiments, the OC layer can be formed using a plurality of support oxides that are metalized using a low loading PGM solution, such as, of platinum (Pt), to form a support oxide/low loading PGM slurry. The support oxide/low loading PGM slurry is then deposited onto the WC layer, and subsequently calcined. Further to these embodiments, support oxides for OC layer are Si-doped alumina (Al₂O₃-5% SiO₂), cerium-zirconia (60% ZrO₂-40% CeO₂), and La-doped alumina (Al₂O₃-10% La₂O₃).

In other embodiments, the disclosed SPGM catalysts for DOC applications are subjected to a DOC/sulfur test methodology to assess/verify NO oxidation activity and resistance to sulfur poisoning. In these embodiments, DOC light-off tests are performed to confirm synergistic effects of ZPGM catalytically active materials in the layered SPGM configuration. Further to these embodiments, the sulfur resistance and NO oxidation of disclosed SPGM catalyst samples are confirmed under a variety of DOC conditions at space velocity (SV) of about 54,000 h⁻¹ and desulfurization, according to a plurality of steps in the test methodology.

Still further to these embodiments, the combined catalytic properties of the layers in SPGM catalyst systems can provide more efficiency in NO oxidation and more stability against sulfur poisoning.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 is a graphical representation illustrating a catalyst structure used for SPGM catalyst samples, according to an embodiment.

FIG. 2 is a graphical representation illustrating a diagram of the steps of a DOC test methodology to assess catalytic activity and resistance to sulfur of SPGM catalysts, according to an embodiment.

FIG. 3 is a graphical representation illustrating results of NO conversion light off (LO) testing conducted on SPGM catalysts according to the DOC test methodology described in FIG. 2, according to an embodiment.

FIG. 4 is a graphical representation illustrating additional results of NO conversion LO testing conducted on SPGM catalysts according to the DOC test methodology described in FIG. 2, according to an embodiment.

FIG. 5 is a graphical representation illustrating further results of NO conversion LO testing conducted on SPGM catalysts according to the DOC test methodology described in FIG. 2, according to an embodiment.

FIG. 6A is a graphical representation illustrating a comparison of NO conversion LO testing that is conducted on SPGM catalysts prior to a sulfation step according to the DOC test methodology described in FIG. 2, according to an embodiment.

FIG. 6B is a graphical representation illustrating a comparison of NO conversion LO testing that is conducted on SPGM catalysts after sulfation according to the DOC test methodology described in FIG. 2, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms have the following definitions:

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat or impregnation layer.

“Support oxide” refers to porous solid oxides, typically mixed metal oxides, which are used to provide a high surface area that enhances the oxygen distribution and exposure of catalysts to reactants, such as, NOₓ, CO, and hydrocarbons.

“Catalyst system” refers to any system including a catalyst, such as, a Platinum Group Metal (PGM) catalyst, or a Zero-PGM (ZPGM) catalyst system, of at least two layers including a substrate, a washcoat, and/or an overcoat.

“Platinum group metals (PGM)” refers to platinum, palladium, ruthenium, iridium, osmium, and rhodium.

“Zero-PGM (ZPGM) catalyst” refers to a catalyst completely or substantially free of platinum group metals.

“Synergized PGM (SPGM) catalyst” refers to a PGM catalyst system which is synergized by a Zero-PGM compound under different configuration.

“Diesel oxidation catalyst” refers to a device that utilizes a chemical process in order to break down pollutants within the exhaust stream of a diesel engine, turning them into less harmful components.

“Perovskite” refers to a ZPGM catalyst, having ABO₃ structure of material, which may be formed by partially substituting element “A” and “B” base metals with suitable non-platinum group metals.

“Metallizing” refers to the process of coating metal on the surface of metallic or non-metallic objects.

“Incipient wetness (IW)” refers to the process of adding solution of catalytic material to a dry support oxide powder until all pore volume of support oxide is filled out with solution and mixture goes slightly near saturation point.

“Conversion” refers to the chemical alteration of at least one material into one or more other materials.

“Poisoning or catalyst poisoning” refers to the inactivation of a catalyst by virtue of its exposure to lead, phosphorus, or sulfur in an engine exhaust.

### DESCRIPTION OF THE DISCLOSURE

The present disclosure is directed to a diesel oxidation catalyst (DOC) system configuration. The DOC configuration includes a 2-layer catalyst having a washcoat (WC) layer including a Zero-PGM (ZPGM) catalyst and an overcoat (OC) layer. The overcoat (OC) layer includes a low loading PGM catalyst. In some embodiments, the 2-layer catalyst improves the conversion rates of NO_{X}, HC, and CO contained within the exhaust gases emitted from an associated diesel engine.

Configuration, Material Composition, and Preparation of SPGM Catalyst Systems

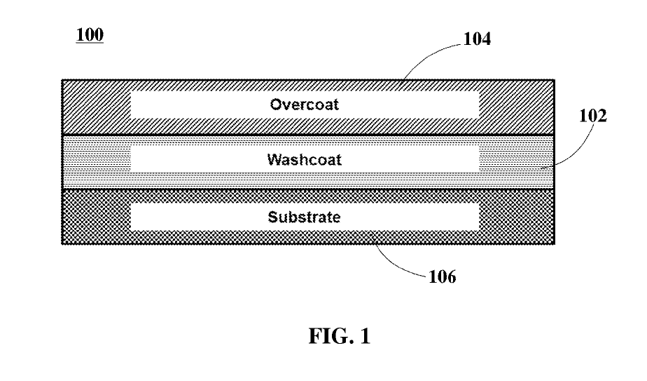

FIG. 1 is a graphical representation illustrating a catalyst structure used for SPGM catalyst samples, according to an embodiment. In FIG. 1, SPGM catalyst structure 100 includes WC layer 102, OC layer 104, and substrate 106. In FIG. 1, WC layer 102 is deposited onto substrate 106 and OC layer 104 is deposited onto WC layer 102. In some embodiments, WC layer 102 is implemented as a ZPGM composition and OC layer 104 is implemented as a low PGM composition.

In other embodiments, SPGM catalyst samples are implemented including WC layer 102 that comprises a perovskite structure of ABO₃, deposited on a support oxide. In these embodiments, OC layer 104 is implemented as including one or more PGM material compositions, deposited onto one or more support oxides. In an example, the one or more PGM material compositions are deposited onto a single support oxide. In another example, the one or more PGM material compositions are deposited onto a mixture of support oxides.

Examples of materials suitable to produce perovskite WC layers with the general formula of ABO₃ include, but are not limited to, silver (Ag), manganese (Mn), yttrium (Y), lanthanum (La), cerium (Ce), iron (Fe), praseodymium (Pr), neodymium (Nd), strontium (Sr), cadmium (Cd), cobalt (Co), scandium (Sc), copper (Cu), and niobium (Nb). Suitable support oxides that are used in WC and OC layers include zirconia (ZrO₂), any doped ZrO₂ including doping such as lanthanide group metals, niobium pentoxide, niobium-zirconia, alumina type support oxide, titanium dioxide, tin oxide, zeolite, silicon dioxide, or mixtures thereof, amongst others. PGM material compositions for depositing on the one or more support oxides include platinum, palladium, ruthenium, iridium, and rhodium, by either themselves, or combinations thereof of different loadings. In an example, a ZPGM catalyst used in a WC layer of a SPGM catalyst structure includes YMnO₃ perovskite structure deposited on a doped ZrO₂ support oxide.

In some embodiments, preparation of the WC layer begins with preparation of a Y—Mn solution. In these embodiments, preparation of the Y—Mn solution includes mixing Y nitrate solution with Mn nitrate solution and water to produce a solution at the appropriate molar ratio. In an example, a Y:Mn molar ratio of 1:1 is used.

In other embodiments, the Y—Mn nitrate solution is added to doped ZrO₂ powder using a conventional incipient wetness (IW) technique forming a Y—Mn/doped ZrO₂ wet powder. In these embodiments, the Y—Mn/doped ZrO₂ wet powder is dried and calcined at about 750° C. for about 5 hours. Further to these embodiments, the calcined Y—Mn/doped ZrO₂ powder is then ground to fine grain for producing YMnO₃/doped ZrO₂ powder. In these embodiments, YMnO₃/doped ZrO₂ powder is mixed with water and subsequently milled to produce a slurry. Further to these embodiments, the slurry is then coated onto a suitable substrate for calcination at about 750° C. for about 5 hours.

In some embodiments, the PGM catalyst used to implement the OC layer includes a PGM solution of platinum (Pt) nitrate deposited onto a support oxide. Examples of support oxides for use in implementing the OC layer include Si-doped alumina (Al₂O₃-5% SiO₂), cerium-zirconia (60% ZrO₂-40% CeO₂), and La-doped alumina (Al₂O₃-10% La₂O₃).

In a first exemplary embodiment, the SPGM catalyst system implemented as SPGM catalyst Type 1 includes an OC layer with a total oxide loading of about 110 g/L. In this embodiment, the preparation of the OC layer includes milling of Si-doped alumina support oxide. Further to this embodiment, the milled Si-doped alumina support oxide is mixed with water to produce an aqueous slurry. Still further to this embodiment, the Si-doped alumina support oxide slurry is metallized by a solution of Pt nitrate with a low loading of about 5 g/ft³. In this embodiment, the OC layer is then deposited onto the WC layer and calcined at about 550° C. for about 4 hours.

In a second exemplary embodiment, the SPGM catalyst system implemented as SPGM catalyst Type 2 includes an OC layer with a total oxide loading of about 110 g/L. In this embodiment, the preparation of the OC layer includes milling cerium-zirconia support oxide. Further to this embodiment, the milled cerium-zirconia support oxide is mixed with water to produce an aqueous slurry. In this embodiment, the cerium-zirconia support oxide slurry is metalized by a solution of Pt nitrate with a low loading of about 5 g/ft³. Further to this embodiment, the OC layer is then deposited onto the WC layer and calcined at about 550° C. for about 4 hours.

In a third exemplary embodiment, the SPGM catalyst system implemented as SPGM catalyst Type 3 includes an OC layer with a total oxide loading of about 110 g/L. In this embodiment, the preparation of the OC layer includes milling La-doped alumina support oxide. Further to this embodiment, the milled La-doped alumina support oxide is mixed with water to produce an aqueous slurry. In this embodiment, the La-doped alumina support oxide slurry is metalized by a solution of Pt nitrate with a low loading of about 5 g/ft³. Further to this embodiment, the OC layer is then deposited onto the WC layer and calcined at about 550° C. for about 4 hours.

DOC LO and Sulfation Test Methodology

In some embodiments, a DOC/sulfur test methodology is applied to SPGM catalyst systems as described in FIG. 1. In these embodiments, the DOC/sulfur test methodology provides confirmation that the disclosed catalyst systems, including a WC layer of ZPGM (e.g., a YMnO₃ perovskite structure) composition with an OC layer of low PGM composition for DOC applications, exhibit increased conversion of gaseous pollutants. Further to these embodiments, the SPGM catalyst compositions produced with low amount of PGM added to ZPGM catalyst materials are capable of providing significant improvements in sulfur resistance.

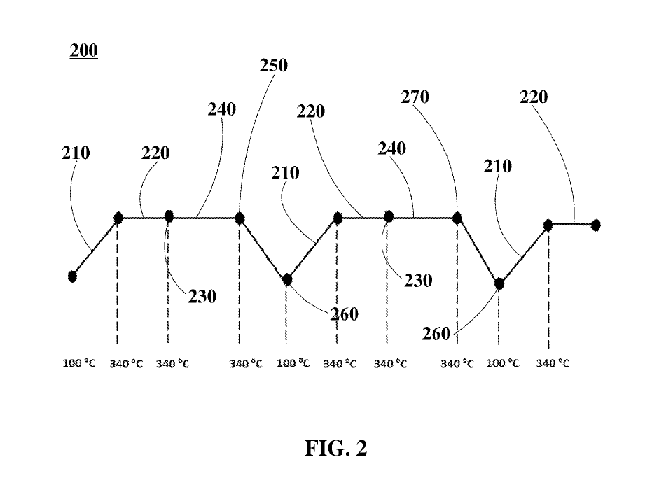

FIG. 2 is a graphical representation illustrating a diagram of steps of a DOC test methodology to assess catalytic activity and resistance to sulfur from SPGM catalysts Type 1, Type 2, and Type 3, according to an embodiment.

In FIG. 2, DOC test methodology 200 employs a standard gas stream composition administered throughout the following steps: DOC light-off (LO), soaking at isothermal DOC condition, and soaking at isothermal sulfated DOC condition. For these embodiments, DOC test methodology 200 steps are enabled during different time periods selected to assess the catalytic activity and resistance to sulfur of the SPGM catalyst samples. Steps in DOC test methodology 200 are implemented at an isothermal temperature of about 340° C. and space velocity (SV) of about 54,000 h⁻¹.

In some embodiments, DOC test methodology 200 begins with DOC LO test 210. The DOC LO test is performed employing a flow reactor with flowing DOC gas composition of about 100 ppm of NO, about 1,500 ppm of CO, about 4% of CO₂, about 4% of H₂O, about 14% of O₂, and about 430 ppmCl of mixed hydrocarbon, while temperature increases from about 100° C. to about 340° C., at SV of about 54,000 h⁻¹. Subsequently, at about 340° C., isothermal soaking under DOC condition 220 is conducted for about one hour to stabilize catalyst performance at about 340° C. At the end of this time period, at point 230, testing under soaking at isothermal sulfated DOC condition 240 begins by adding a concentration of about 3 ppm of SO₂ to the gas stream for about 4 hours. At the end of this time period, at point 250, the sulfation process is stopped when the amount of SO₂ passed to catalyst is about 0.9 gS/L of substrate. Subsequently, the flowing gas stream is allowed to cool down to about 100° C., at point 260. After this point, DOC test methodology 200 continues by conducting another cycle of test steps including DOC LO test 210, isothermal soaking under DOC condition 220 for about one hour, and sulfated DOC condition 240, flowing about 3 ppm of SO₂ for about 2 hours in the gas stream, until reaching a total SO₂ passed to catalyst of about 1.3 gS/L of substrate at point 270, when sulfation of the gas stream is stopped. Finally, the catalyst activity of the SPGM catalyst samples is determined by conducting another DOC LO and isothermal sulfation soaking for a total of about 6 hours, followed by a desulfurization (de-SOx) process step (not shown in FIG. 2) at about 600° C. for about one hour. NO conversion and sulfur resistance are compared at the end of test for all the DOC conditions (i.e., before and after sulfation, in the test methodology and de-Sox).

SPGM Catalyst Activity Under DOC Light Off Before and after Sulfation and De-SOx

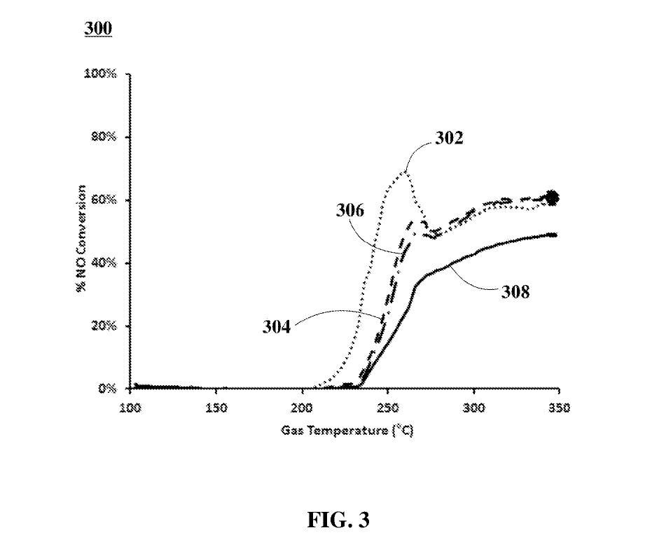

FIG. 3 is a graphical representation illustrating results of NO conversion light off (LO) for SPGM catalysts Type 1 tested according to the DOC test methodology described in FIG. 2, according to an embodiment.

In FIG. 3, four specific conversion curves are detailed as follows: conversion curve 302 illustrates % NO conversion LO before sulfation, under DOC LO test 210 and isothermal soaking under DOC condition 220; conversion curve 304 illustrates % NO conversion LO after sulfation and under sulfated DOC condition 240 for about 4 hours, SO₂ concentration of about 0.9 gS/L; conversion curve 306 illustrates % NO conversion after sulfation and under sulfated DOC condition 240 for a second period of about 2 hours, (a total sulfation time of about 6 hours), with total SO₂ concentration of about 1.3 gS/L; and conversion curve 308 illustrates % NO conversion after de-SOx at about 600° C. for about one hour.

In some embodiments, NO oxidation, as defined by conversion curve 302, reaches a maximum NO conversion of about 69.10% at about 259° C. In these embodiments, after sulfation with either about 0.9 gS/L or about 1.3 gS/L rate, as illustrated by conversion curves 304 and 306, respectively, a decrease in NO conversion is observed in lower temperature ranges. Further to these embodiments, at a higher range of temperature from about 275° C. to about 340° C., NO conversion of the SPGM catalyst Type 1 exhibits substantially similar catalytic behavior before and after sulfation within an average NO conversion of about 60%. This NO oxidation LO indicates a significant high sulfur resistance of the SPGM catalyst Type 1, as illustrated by constant NO conversion LO after sulfation with either about 0.9 gS/L or about 1.3 gS/L rate. In these embodiments, conversion curve 308 illustrates that after de-SOx process, the SPGM catalyst Type 1 exhibits a NO conversion of about 48.5% at about 340° C. Further to these embodiments, after de-SOx, the SPGM catalyst Type 1 does not exhibit enhanced activity recovery activity after sulfur accumulated within the catalyst is desorpted.

Test results provide confirmation that the disclosed SPGM catalyst Type 1 exhibits significantly high catalyst performance efficiency and sulfur resistance.

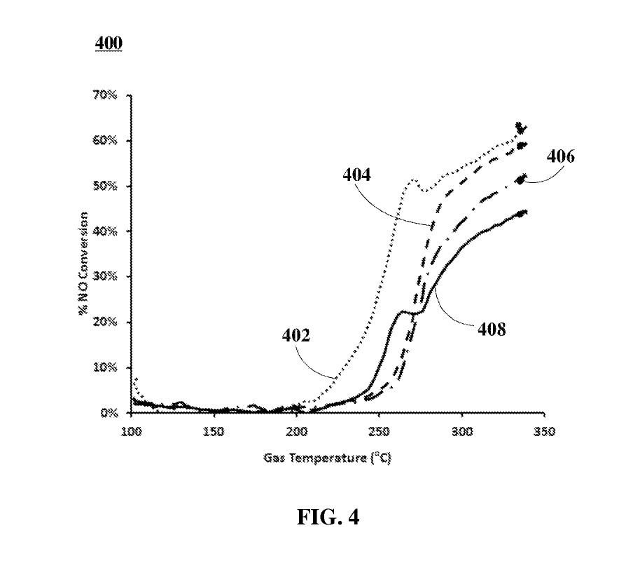

FIG. 4 is a graphical representation illustrating results of NO conversion LO for SPGM catalysts Type 2 tested according to the DOC test methodology described in FIG. 2, according to an embodiment.

In FIG. 4, four specific conversion curves are detailed as follows: conversion curve 402 illustrates % NO conversion LO before sulfation, under DOC LO test 210 and isothermal soaking under DOC condition 220; conversion curve 404 illustrates % NO conversion LO after sulfation and under sulfated DOC condition 240 for about 4 hours, SO₂ concentration of about 0.9 gS/L; conversion curve 406 illustrates % NO conversion after sulfation and under sulfated DOC condition 240 for a second period of about 2 hours, (a total sulfation time of about 6 hours), with SO₂ concentration of about 1.3 gS/L; and conversion curve 408 illustrates % NO conversion after de-SOx at about 600° C. for about one hour.

In some embodiments, NO oxidation as defined by conversion curve 402, reaches to NO conversion of about 51.20% at about 269° C., followed by a rapid increase in NO conversion to about 63% at a higher temperature range from about 278° C. to about 340° C. In these embodiments, after sulfation with either about 0.9 gS/L or about 1.3 gS/L rate, as illustrated by conversion curves 404 and 406, a decrease in NO conversion is observed within the whole range of temperature. Further to these embodiments, after sulfation with about 0.9 gS/L rate, NO conversion in conversion curve 404 exhibits a slight decrease in comparison to NO conversion in conversion curve 402, which exhibits a NO conversion of about 58.8% at about 340° C. In these embodiments, after sulfation with about 1.3 gS/L rate, NO conversion in conversion curve 406 exhibits a larger decrease in comparison to NO conversion in conversion curve 402, which exhibits NO conversion of about 51.1% at about 340° C. In these embodiments, it is also observed in conversion curve 408 that after de-SOx process, the SPGM catalyst Type 2 maintains a significant % NO conversion of about 45% at about 340° C. Further to these embodiments, after de-SOx, the SPGM catalyst Type 2 exhibits enhanced recovery after sulfur accumulated within the catalyst is desorpted at lower temperature range below 275° C.

Test results provide confirmation that the disclosed SPGM catalyst Type 2 exhibits significantly high catalyst performance efficiency and sulfur resistance.

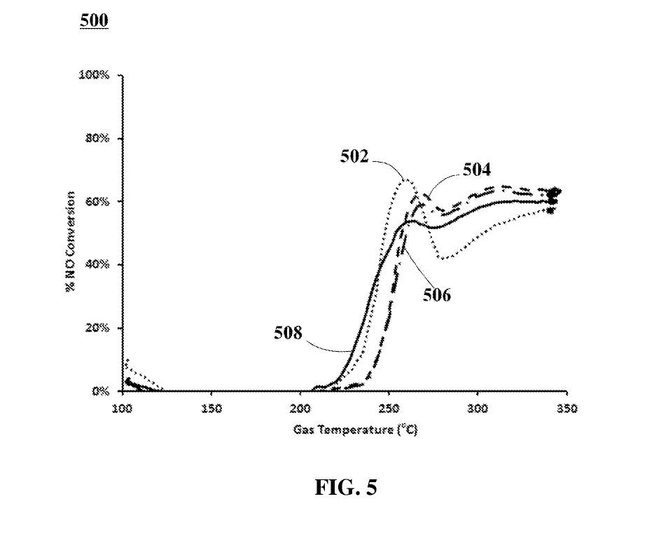

FIG. 5 is a graphical representation illustrating results of NO conversion LO for SPGM catalysts Type 3 tested according to the DOC test methodology described in FIG. 2, according to an embodiment.

In FIG. 5, four specific conversion curves are detailed as follows: conversion curve 502 illustrates % NO conversion LO before sulfation, under DOC LO test 210 and isothermal soaking under DOC condition 220; conversion curve 504 illustrates % NO conversion LO after sulfation and under sulfated DOC condition 240 for about 4 hours, SO₂ concentration of about 0.9 gS/L; conversion curve 506 illustrates % NO conversion after sulfation and under sulfated DOC condition 240 for a second period of about 2 hours, (a total sulfation time of about 6 hours), with SO₂ concentration of about 1.3 gS/L; and conversion curve 508 illustrates % NO conversion after de-SOx at about 600° C. for about one hour.

In some embodiments, NO oxidation, as defined by conversion curve 502, reaches a maximum NO conversion of about 67.10% at about 260° C., followed by a decrease in NO conversion of about 59.6% at about 340° C. In these embodiments, after sulfation with either about 0.9 gS/L or about 1.3 gS/L rate and at a lower temperature range (e.g., below 265° C.), % NO oxidation as illustrated in conversion curve 502 is higher than % NO oxidation as illustrated in conversion curves 504 and 506. Further to these embodiments, at higher range of temperature (about 265° C. to about 340° C.), NO conversion of the SPGM catalyst Type 3 exhibits higher catalytic behavior after sulfation with about 60.9% at about 340° C. This NO oxidation LO exhibits significant high sulfur resistance of the SPGM catalyst Type 3. In these embodiments, it is also observed in conversion curve 508 that after de-SOx process, the SPGM catalyst Type 3 maintains a significant % NO conversion of about 60% at about 340° C. Further to these embodiments, after de-SOx, the SPGM catalyst Type 3 exhibits enhanced recovery activity after sulfur accumulated within the catalyst is desorpted in almost the whole range of temperature.

Test results allow confirmation that the disclosed SPGM catalyst Type 3 exhibits significantly high catalyst performance efficiency and sulfur resistance.

Effect of Type of Support Oxides on Activity and Sulfur Resistance of SPGM Catalysts

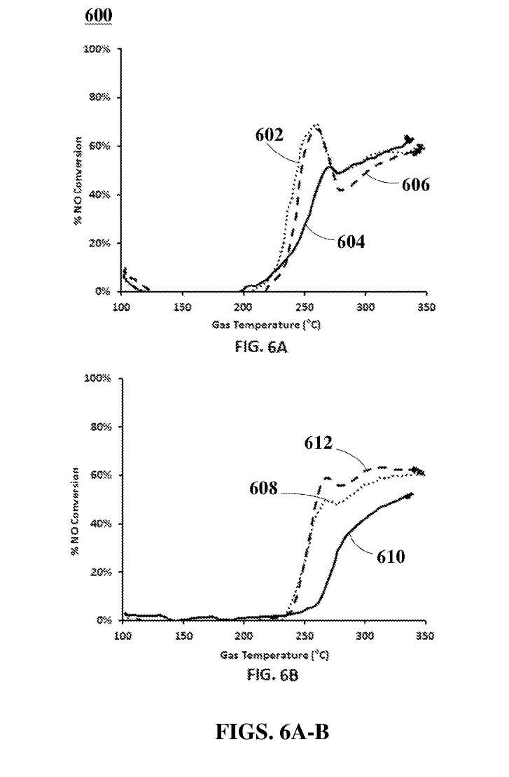

FIGS. 6A and 6B illustrate NO conversion comparisons of LO testing before and after the sulfation step, respectively, for SPGM catalysts Type 1, Type 2, and Type 3 tested according to the DOC test methodology described in FIG. 2, according to an embodiment. FIG. 6A illustrates NO conversion comparisons of LO testing before the sulfation step for SPGM catalysts Type 1, Type 2, and Type 3 that are tested according to the DOC test methodology. FIG. 6B illustrates NO conversion comparisons of LO testing after the sulfation step for SPGM catalysts Type 1, Type 2, and Type 3 tested according to the DOC test methodology.

In FIG. 6A, three specific conversion curves are detailed as follows: conversion curve 602 illustrates % NO conversion LO test results for SPGM catalyst Type 1; conversion curve 604 illustrates % NO conversion LO test results for SPGM catalyst Type 2; and conversion curve 606 illustrates % NO conversion LO test results for SPGM catalyst Type 3.

In some embodiments, at a lower range of temperatures (e.g., below 270° C.), NO oxidation illustrated in conversion curves 602 and 606 exhibits higher NO conversion as compared to NO conversion illustrated in conversion curve 604. The NO oxidation illustrated in conversion curves 602 and 606 indicates catalysts Type 1 (Si-doped alumina support oxide) and Type 3 (La-doped alumina support oxide) exhibit lower NO conversion LO test results as compared to catalyst Type 2 (ceria-zirconia support oxide). In these embodiments, at a higher range of temperature (e.g., above 270° C.), NO oxidation of SPGM Type 3 exhibits a greater decrease when compared to NO oxidation of catalysts Type 1 and Type 2.

Test results provide confirmation that the disclosed SPGM catalysts including Si-doped (Type 1) and La-doped (Type 3) alumina support oxides within the OC layer exhibit lower NO oxidation LO test results and include a maximum NO conversion of about 68% at about 260° C. Alternatively, SPGM catalysts including ceria-zirconia support oxide (Type 2) within the OC layer exhibit a higher NO conversion resistance within a wide range of temperatures before exposure to sulfur poisons.

In FIG. 6B, three specific conversion curves are detailed as follows: conversion curve 608 illustrates % NO conversion LO test results for SPGM catalyst Type 1; conversion curve 610 illustrates % NO conversion LO test results for SPGM catalyst Type 2; and conversion curve 612 illustrates % NO conversion LO test results for SPGM catalyst Type 3, after sulfation with about 1.3 gS/L rate.

In some embodiments, after sulfation with about 1.3 gS/L rate, NO oxidation of SPGM catalyst Type 3 exhibits higher sulfur resistance as compared to SPGM catalysts Type 1 and Type 2. In these embodiments, at a lower range of temperature (e.g., below 257° C.), SPGM catalysts Type 1 (Si-doped alumina support oxide) and Type 3 (La-doped alumina support oxide) exhibit substantially similar sulfur resistance, as illustrated with overlap NO conversion LO after 1.3 gS/L sulfation. Further to these embodiments, at a higher range of temperature (e.g., above 257° C.), SPGM catalyst Type 3 (La-doped alumina support oxide) exhibits a higher NO conversion than SPGM catalyst Type 1 (Si-doped alumina support oxide). In these embodiments, SPGM catalyst Type 2 (ceria-zirconia support oxide) exhibits lower NO conversion after 1.3 g S/L sulfation within the whole range of temperatures.

According to the principles of this present disclosure, the effect of support oxide variations on the OC layer of the ZPGM catalyst illustrates different catalyst performance efficiencies and sulfur resistances. The catalytic performance and sulfur resistance are determined based on the DOC LO test results of the disclosed SPGM catalysts Type 1, Type 2 and Type 3 before and after sulfation. In the present disclosure, the DOC test results of the 2-layer SPGM catalysts indicate the 2-layer SPGM catalysts are capable of providing significant improvements in the sulfur resistance of SPGM catalyst systems. Additionally, the disclosed SPGM catalysts are significantly stable after long-term sulfation exposure and further exhibit a high level of acceptance of NO conversion stability.

The diesel oxidation properties of the disclosed 2-layer SPGM catalyst systems indicate that under diesel operating conditions the SPGM chemical composition is more efficient as compared to conventional DOC systems.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A catalyst system, comprising:
a substrate,
a washcoat including YMnO₃ perovskite and a doped ZrO₂ support oxide, and
an overcoat including a platinum group metal catalyst and a support oxide selected from the group consisting of Si-doped alumina, cerium-zirconia, and La-doped alumina,
wherein the washcoat is free of platinum group metal catalyst.

2. The catalyst system of claim 1, wherein the platinum group metal catalyst is loaded in the overcoat at about 5 g/ft³.

3. The catalyst system of claim 1, wherein the support oxide included in the overcoat includes Si-doped alumina.

4. The catalyst system of claim 3, wherein the Si-doped alumina comprises about 5% by weight SiO₂.

5. The catalyst system of claim 1, wherein the support oxide included in the overcoat includes La-doped alumina.

6. The catalyst system of claim 5, wherein the La-doped alumina comprises about 10% by weight La₂O₃.

7. The catalyst system of claim 2, wherein the support oxide included in the overcoat includes Si-doped alumina comprising about 5% by weight SiO₂.

8. The catalyst system of claim 2, wherein the support oxide included in the overcoat includes La-doped alumina comprising about 10% by weight La₂O₃.

9. The catalyst system of claim 1, wherein the platinum group metal catalyst is platinum nitrate and the platinum nitrate is loaded in the overcoat at about 5 g/ft³.

10. The catalyst system of claim 4, wherein the platinum group metal catalyst is platinum nitrate and the platinum nitrate is loaded in the overcoat at about 5 g/ft³.

11. A method of manufacturing a catalyst system comprising:
applying a first slurry of calcined Y—Mn/doped ZrO₂ powder on a substrate and calcining at a second calcination temperature for a second calcination period to form a washcoat layer,
depositing a second slurry including Si-doped alumina, water, and platinum nitrate on the washcoat layer, and
calcining at a third calcination temperature for a third calcination period to form an overcoat layer.

12. The method of claim 11 further comprising:
an incipient wetness technique to form a Y—Mn/doped ZrO₂ wet powder,
drying the Y—Mn/doped ZrO₂ wet powder and calcining at a first calcination temperature for a first calcination period to form the calcined Y—Mn/doped ZrO₂ powder,
grinding the calcined Y—Mn/doped ZrO₂ powder to form fine grained Y—Mn/doped ZrO₂ powder,
mixing the fine grained Y—Mn/doped ZrO₂ powder to form the first slurry.

13. The method of claim 11 further comprising:
milling Si-doped alumina,
mixing Si-doped alumina with water and platinum nitrate to form the second slurry.

14. The method of claim 11, wherein the second calcination temperature is about 750° C.

15. The method of claim 14, wherein the second calcination period is about 5 hours.

16. The method of claim 12, wherein the first calcination temperature is about 750° C.

17. The method of claim 16, wherein the first calcination period is about 5 hours.

18. The method of claim 11, wherein the third calcination temperature is about 550° C.

19. The method of claim 18, wherein the first calcination period is about 4 hours.

20. The method of claim 12 further comprising:
milling Si-doped alumina,
mixing Si-doped alumina with water and platinum nitrate to form the second slurry,
wherein the first calcination temperature is about 750° C., the second calcination temperature is about 750° C., and the third calcination temperature is about 550° C.
